(19) United States
(12) Patent Application Publication
(10) Pub. No.: US 2007/0227830 A1
(43) Pub. Date: Oct. 4, 2007

(54) FAILSAFE BRAKE FOR COUNTERWEIGHT ARBORS/COUNTERWEIGHT ASSISTED THEATRICAL RIGGING SYSTEMS

(75) Inventors: Peter V. Svitavsky, Port Byron, NY (US); Stephen J. Kochan, Skaneateles, NY (US)

Correspondence Address: BOND, SCHOENECK & KING, PLLC, ONE LINCOLN CENTER, SYRACUSE, NY, 13202-1355, US

(73) Assignee: J.R. CLANCY, INC., Syracuse, NY (US)

(21) Appl. No.: 11/676,843

(22) Filed: Feb. 20, 2007

Related U.S. Application Data
(60) Provisional application No. 60/774,368, filed on Feb. 17, 2006.

(51) Int. Cl. B66B 5/12

(52) U.S. Cl. 187/366

(57) ABSTRACT

A failsafe brake is provided for preventing the uncontrolled descent of a counterweight arbor or stage equipment load in a counterweight rigging systems. Specifically provided is a failsafe brake according to which a brake shoe is biased to contact a counterweight arbor guide rail and grip it between the brake shoe and a backer plate, except when tension is applied to a line to move the counterweight arbor.

### Claim of Priority

The present application claims priority to U.S. Provisional Application Ser. No. 60/774,368, filed Feb. 17, 2006, the entirety of which is hereby incorporated by reference.

### FIELD OF THE INVENTION

The present invention relates generally to brakes for theatrical rigging systems, and more specifically to a failsafe break that can be used with theatrical rigging systems that include a manually operated counterweight arbor or a motor-assisted counterweight.

### BACKGROUND OF THE INVENTION

Theatrical rigging systems provide a means for raising and lowering scenery, lights, curtains and other stage equipment necessary for a theatrical production. In counterweight rigging systems, the weight of the equipment hanging over the stage is balanced by an arbor hanging off stage that contains enough weight to partially or completely balance the load of the equipment. The system is actuated by means of a hand or drive line attached to the counterweight that can be pulled up or down to move the load in either direction. Counterweight systems can either be motorized, in which case a motorized winch is used to raise and lower the stage equipment, or manual, in which case manual power is applied to ropes to raise and/or lower the stage equipment.

Stage equipment can be extremely dangerous if it falls in an uncontrolled manner. Counterweight rigging systems, whether motorized or manual, typically include a brake to fix the hand or drive lines in position until the operator intentionally raises or lowers the stage equipment. Such brakes, however, do not protect against all types of uncontrolled descent. In the case of counterweight systems and motor assisted counterweight systems, it is possible for the counterweight arbor and the stage equipment load to be out of balance, but fixed in position by a hand or drive line or rope lock. In such case either the stage equipment or the counterweight arbor will fall in an uncontrolled manner when the brake is inadvertently released, or if the hand or drive line were to fail. What is needed for such systems is a failsafe brake that prevents the stage equipment load and the counterweight arbor from moving except when tension is applied to the hand line or drive line.

### SUMMARY OF THE INVENTION

The present invention provides a failsafe brake for a motor assisted or manual counterweight rigging system. According to the present invention, a counterweight arbor is provided, which engages and moves linearly relative to a counterweight arbor guide rail. The counterweight arbor includes a fixed backer plate and a brake shoe that is biased toward to the backer plate in such a way that the guide rail can be gripped between the brake shoe and the backer plate to prevent motion of the counterweight arbor relative to the counterweight arbor guide rail. When the operator of the rigging system applies tension to a hand line or drive line connected to the counterweight arbor, the brake shoe disengages from the guide rail and allows the counterweight arbor to move relative to the guide rail. In this fashion, the counterweight arbor is allowed to move only when tension is being applied to the hand line or drive line.

In one aspect, the present invention provides a brake assembly for a theatrical rigging system that includes a counterweight arbor, a guide rail, and a line operable between neutral and actuated states and for effecting movement of the arbor along the guide rail when in the actuated state, wherein the brake assembly comprises a braking element connected to the line and movable between engaged and disengaged relation to the guide rail, a bias element operably associated with the braking element, and wherein the braking element is in engaged relation to the guide rail when the line is in its neutral state and in disengaged relation to the guide rail when the line is in its actuated state.

In one embodiment, the brake element generally comprises a cam eccentrically rotatable relative to the guide rail. In this embodiment, the brake assembly further comprises an axle on which the cam is mounted and a yoke rotatably mounted on the axle, wherein the bias element comprises a torsion spring mounted on the axle and connected at one end to the cam and at its opposite end to the yoke.

In a second embodiment, the brake element comprises a shoe attached to the line and movable between engaged and disengaged relation to the guide rail, and a pair of linkage arm that pivotally interconnect said shoe to the arbor. The shoe is adapted to move laterally between the guide rail and the arbor.

### DESCRIPTION OF THE DRAWINGS

The present invention will be more fully understood and appreciated by reading the following Detailed Description in conjunction with the accompanying drawings, in which:

FIG. 1 is a side elevation view of a counterweight rigging system in which the present invention can be installed;

FIG. 2 is a partial side elevation view of a failsafe brake according to one embodiment of the present invention;

FIG. 3 is a partial perspective view of a counterweight rigging system that includes a failsafe break according to an embodiment of the present invention;

FIG. 4 is a partial top view of a failsafe brake according to an embodiment of the present invention.; and

FIG. 5 is a partial side elevation view of another embodiment of a failsafe brake according to the present invention.

### DETAILED DESCRIPTION

Referring now to the drawings, wherein like reference numbers refer to like parts throughout, there is seen in FIG. 1 a counterweight rigging system that includes a counterweight arbor 10, a counterweight arbor guide rail 12, a hand line 14, lift lines 16 and a batten 18 for containing a load of stage equipment. In a motor-assisted counterweight system, there will also be a winch (not shown) and the hand line 14 will be replaced with a drive line (not shown).

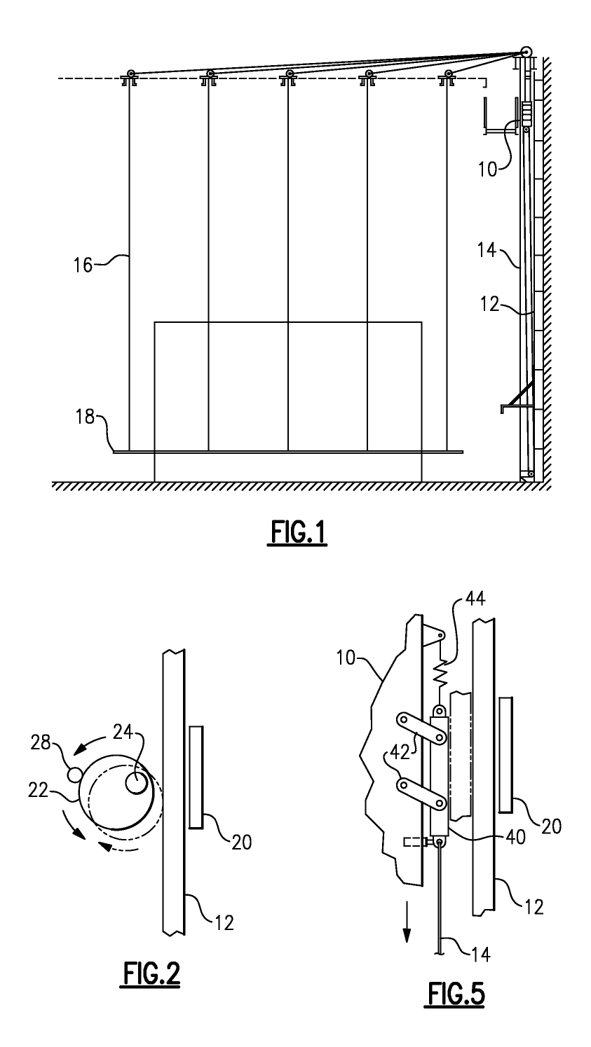

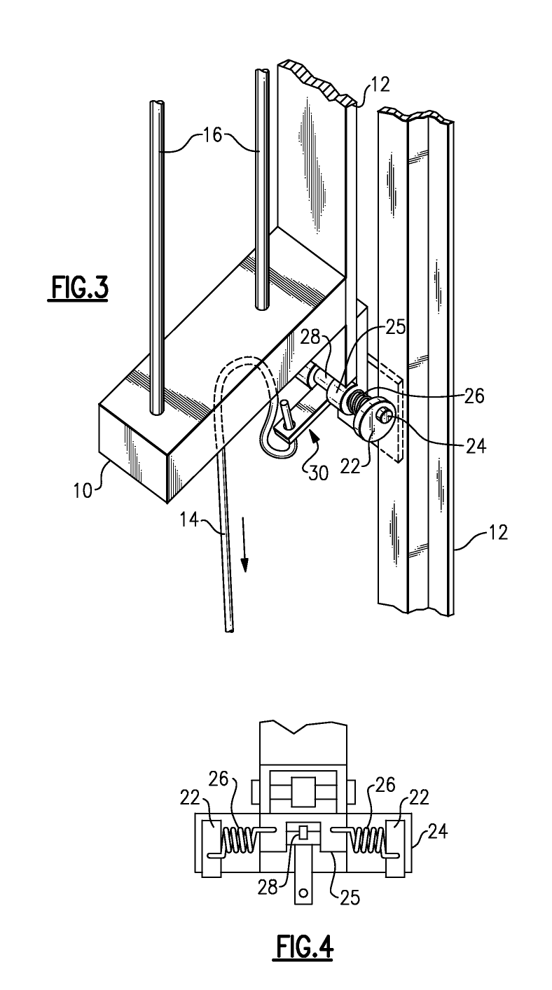

Referring now to FIG. 2, there is shown a failsafe brake according to an embodiment of the present invention, comprising backer plate 20, guide rail 12 and cam 22. Cam 22 is rotatably connected to counterweight arbor 10 and rotates around an eccentrically offset axle (or pivot point 24) such that it can rotate into contact with the guide rail 12 or rotate out of contact with guide rail 12. The contact surface of cam 22 may include teeth, coatings, or other features to increase the friction between the cam 22 and the guide rail 12. The geometry of this cam may be such that the force imposed onto the brake components by the rigging system will increase the force from the brake that resists motion in that direction. Torsion spring 26 (FIG. 3) is mounted to axle 24 and attached at one end to cam 22 and at the opposite end to a yoke 25 that is also rotatably mounted on axle 24. Spring 26 biases cam 22 into contact with guide rail 12. A stop pin 28 mounted on axle 24 adjacent yoke 25 limits the outward rotation of cam 22 and creates a rigid load path for the tension transmitted by the hand or drive line to move the arbor, but permits cam 22 to rotate sufficiently far that it can be completely disengaged from guide rail 12. Backer plate 20 is connected to counterweight arbor 10. Backer plate 20 is preferably made of steel, although it may be provided with a friction material lining or other features to allow it to work with the cam 22 to grip the rail 12. When cam 22 is not exerting pressure on guide rail 12, backer plate 20 slidably engages guide rail 12.

In operation, when counterweight arbor 10 is in an elevated position and begins an uncontrolled descent, cam 22 biases against guide rail 12. Vertical movement of counterweight arbor 10 relative to guide rail 12 and friction between cam 22 and guide rail 12 causes further rotation of cam 22 against guide rail 12, pulling backer plate 20 toward the back surface of guide rail 12 and increasing the pressure exerted on guide rail 12 between cam 22 and backer plate 20. The pressure exerted by cam 22 and backer plate 20 is sufficient to brake the vertical movement of counterweight arbor 10.

Referring now to FIG. 3, there is shown torsion spring 26, which biases cam 22 against guide rail 12. Also shown is release arm 30, which is connected to hand line 14. When tension is applied to hand line 14, release arm 30 causes cam 22 to rotate out of engagement with counterweight arbor guide rail 12, which permits counterweight arbor 10 to move relative to guide rail 12. Other connections between hand line 14 and release arm 30 are acceptable, provided they allow cam 22 to engage guide rail 12 when there is no tension on hand line 14 and also cause cam 22 to disengage guide rail 12 when tension is applied to hand line 14. In addition, a direct connection between lift line 14 and cam 22 is acceptable provided it allows cam 22 to engage guide rail 12 when there is no tension on hand line 14 and also causes cam 22 to disengage guide rail 12 when tension is applied to hand line 14.

According to another embodiment of the present invention, shown in FIG. 5, a shoe 40 can be used in place of cam 22. According to this embodiment, shoe 40 is rotatably attached to one end of two linkage arms 42 that are vertically spaced relative to one another. The opposite ends of linkage arms 42 are rotatably attached to counterweight arbor 10. A biasing element 44 biases shoe 40 so that it rotates away from counterweight arbor 10 and into contact with guide rail 12. Hand line 14 is connected directly or indirectly to shoe 40 so that when tension is applied to hand line 14, shoe 40 rotates out of contact with guide rail 12, and includes a stop pin 44 that engages arbor 10 to prevent over-rotation of shoe 40 and maintain space between shoe 40 and arbor 10. The relative geometry of shoe 40, arms 42 and their points of rotation with respect to counterweight arbor 10 preferably is selected such that a substantial portion of the force produced by movement of counterweight arbor 10 parallel to the guide rail 12 is translates into force from the shoe 40 against, and generally perpendicular to, the guide rail 12.

Typically, a counterweight arbor 10 engages two guide rails 12 that are laterally separated as shown in FIG. 3. Preferably, therefore, a failsafe brake system according to the present invention would include a plurality of cams 22 or shoes 40 so that the failsafe brake can engage a plurality of guide rails 12.

Preferably, counterweight arbor 10 includes two failsafe brakes according to the present invention. A first brake would be positioned on counterweight arbor 10 to prevent movement of the counterweight arbor 10 relative to the guide rail 12 in a first direction and a second failsafe brake would be positioned on the counterweight arbor 10 to prevent movement of the counterweight arbor 10 relative to the guide rail 12 in a second direction.

While there has been illustrated and described what are at present considered to be preferred and alternate embodiments of the present invention, it should be understood and appreciated that modifications may be made by those skilled in the art and that the appended claims encompass all such modifications that fall within the full spirit and scope of the present invention.

What is claimed is:

1. A brake assembly for a theatrical rigging system that includes a counterweight arbor, a guide rail, and a line operable between neutral and actuated states and for effecting movement of the arbor along the guide rail when in the actuated state, said brake assembly comprising:
a. a braking element movable between engaged and disengaged relation to the guide rail;
b. a bias element operably associated with said braking element; and
c. said braking element being connected to the line, wherein said braking element is in said engaged relation to the guide rail when the line is in its neutral state and in said disengaged relation to the guide rail when the line is in its actuated state.

2. The brake assembly according to claim 1, wherein said braking element comprises a cam eccentrically rotatable relative to the guide rail.

3. The brake assembly according to claim 2, further comprising an axle on which said cam is mounted and a yoke rotatably mounted on said axle, and wherein said bias element comprises a torsion spring mounted on said axle and connected at one end to said cam and at its opposite end to said yoke.

4. The brake assembly according to claim 3, further comprising an elongated release arm mounted to said axle and attached to the line, and having a stop pin extending outwardly therefrom, said stop pin being pivotally movable between engaged and disengaged relation relative to the arbor.

5. The brake assembly according to claim 1, wherein said braking element comprises a shoe movable between engaged and disengaged relation to the guide rail, and a pair of linkage arm that pivotally interconnect said shoe to the arbor.

6. The brake assembly according to claim 5, wherein said bias element comprises a spring that extends between the arbor and said shoe.

7. The brake assembly according to claim 6, wherein said shoe is attached to the line and when the line is in its neutral state said shoe is in its said engaged relation relative to the guide rail and when the line is in its actuated state said shoe is in its said disengaged relation relative to the guide rail.

8. The brake assembly according to claim 7, wherein said shoe is adapted to move laterally between the guide rail and the arbor.
